(19) United States
(12) Patent Application Publication
(10) Pub. No.: US 2024/0206541 A1
(43) Pub. Date: Jun. 27, 2024

(54) PLANAR HEATING ELEMENT FOR GENERATING AEROSOL, METHOD FOR MANUFACTURING THE SAME, AND AEROSOL-GENERATING DEVICE COMPRISING THE SAME

(71) Applicant: KT&G CORPORATION, Daejeon (KR)

(72) Inventors: Chul Ho JANG, Daejeon (KR); Gyoung Min GO, Daejeon (KR); Hyung Jin BAE, Daejeon (KR); Jang Won SEO, Daejeon (KR); Min Seok JEONG, Daejeon (KR); Jong Seong JEONG, Daejeon (KR); Jin Chul JUNG, Daejeon (KR)

(73) Assignee: KT&G CORPORATION, Daejeon (KR)

(21) Appl. No.: 17/919,864

(22) PCT Filed: Jun. 30, 2022
(86) PCT No.: PCT/KR2022/009393

§ 371 Date: Oct. 19, 2022

(30) Foreign Application Priority Data
Jul. 27, 2021 (KR) 10-2021-0098478

(51) Int. Cl. A24F 40/46; A24F 40/10; A24F 40/44; A24F 40/70; H05B 3/22

(52) U.S. Cl. CPC A24F 40/46; A24F 40/10; A24F 40/44; A24F 40/70; H05B 3/22

(57) ABSTRACT

The present invention relates to a planar heating element for generating an aerosol comprising a porous wick for absorbing a liquid aerosol-generating substrate, a conductive bead layer for heating the absorbed liquid aerosol-generating substrate, and a terminal part for delivering an electricity for heating to the conductive bead layer, a method for manufacturing the same, and an aerosol-generating device comprising the same.

### TECHNICAL FIELD

The present invention relates to a planar heating element for generating an aerosol, a method for manufacturing the same, and an aerosol-generating device comprising the same, and specifically to a planar heating element for generating an aerosol by generating a planar heat through a conductive bead layer, a method for manufacturing the same, and an aerosol-generating device comprising the same.

This application claims the benefit of priority based on Korean Patent Application No. 10-2021-0098478 filed on Jul. 27, 2021, the entire contents of which are incorporated herein as part of the present specification.

### BACKGROUND ART

In recent years, there is an increasing demand for alternative smoking articles to overcome the general disadvantages of cigarettes. For example, there is an increasing demand for a device for generating an aerosol by heating a liquid aerosol-generating substrate, rather than a method of generating an aerosol by burning conventional cigarettes, and researches on this are being actively conducted.

The aerosol-generating device using a method of heating a liquid aerosol-generating substrate comprises a wick-heater structure in which a wick for absorbing the liquid aerosol-generating substrate and a heater for heating the liquid are combined.

The wick is generally made of a fiber bundle composed of a cotton silica material. The wick-heater structure is manufactured by locating a heater in a pattern form made of a conductive metal on or just below the surface of the wick, and an aerosol-generating device using a method of heating a heater electrically to vaporize a liquid aerosol-generating substrate absorbed through the wick is used.

However, as described above, in the case of the aerosol-generating device comprising a heater in a certain pattern form on the lower surface or just below the surface of the wick, local heating occurs only at a position corresponding to the pattern due to the limitation of the pattern size, so there is a non-heating area. Due to this, since local heating with a deviation for each area of the wick occurs, burnt taste or harmful substances due to the liquid carbonization phenomenon were concentrated in the pattern area, and thermal shrinkage or thermal expansion due to the difference in physical properties of the wick occurred, resulting in separation of the wick and the pattern.

An attempt has been made to increase the amount of aerosol generated by generating heat in a wide area at low power density by using a mesh network in the wick instead of using the heater in a pattern form, but the liquid carbonization phenomenon due to instantaneous heating, which is a problem with the fiber-based wick itself, was still not solved, and there was a deviation in heating for each area as in the case of the heater in a conventional pattern form due to the mesh structure.

In addition, an attempt was made to replace the entire wick with a bead structure comprising a conductive material instead of comprising the heater as a separate component, but there were problems in that the aerosol-generating area could not be predicted because the heating occurred randomly in the entire area of the wick structure, and local heating occurred because the inside of the wick was divided into a heated part and a non-heated part, and there were also difficulties in the design for configuring the current flow in one direction when configuring the terminal.

Therefore, there is a need for research to solve the above-mentioned problems in which heating occurs locally only in a specific area of the wick or heating occurs randomly in an irregular area, in the aerosol-generating device. [Prior Art Document]

### PATENT DOCUMENTS

(Patent Document 1) Korean Laid-Open Patent Application No. 10-2018-0118124, entitled “E-vaping cartridge and device”

### DISCLOSURE

### Technical Problem

In order to solve the above-mentioned problems, the present inventors intend to provide a planar heating element for generating an aerosol by generating an aerosol without deviation for each area due to heat generation on one surface of the wick, a method for manufacturing the same, and an aerosol-generating device comprising the same.

### Technical Solution

According to a first aspect of the present invention, there is provided a planar heating element for generating an aerosol, comprising a porous wick for absorbing a liquid aerosol-generating substrate; a conductive bead layer for heating the absorbed liquid aerosol-generating substrate; and a terminal part for delivering an electricity for heating to the conductive bead layer.

In one embodiment of the present invention, the conductive bead layer may be a layer having a plurality of conductive beads stacked on one surface of the porous wick.

In one embodiment of the present invention, the conductive bead layer may be a planar heating layer for heating the conductive beads stacked on one surface of the porous wick by electricity delivered from the terminal part.

In one embodiment of the present invention, the conductive beads may be selected from the group consisting of conductive metal beads, beads having a surface coated with a conductive material, and combinations thereof.

In one embodiment of the present invention, the conductive beads may have an average diameter of 50 to 200 μm.

In one embodiment of the present invention, the conductive bead layer may have an average thickness of 0.1 to 1.5 mm.

In one embodiment of the present invention, the ratio (A/B) of the average thickness of the porous wick (A) to the conductive bead layer (B) may be 0.1 to 5.

In one embodiment of the present invention, the porous wick is a structure comprising porous beads, and the porous beads may be selected from the group consisting of glass beads, ceramic beads, alumina beads, and combinations thereof.

In one embodiment of the present invention, the terminal part may comprise a first terminal and a second terminal respectively located separately at both ends of the conductive bead layer.

According to a second aspect of the present invention,
there is provided a method for manufacturing the planar heating element for generating an aerosol, comprising the steps of: (1) stacking conductive beads on one surface of a fired porous wick to form a conductive bead layer; (2) further firing the porous wick having the formed conductive bead layer; and (3) adhering a first terminal and a second terminal to both ends of the conductive bead layer, respectively.

According to a third aspect of the present invention,
there is provided a method for manufacturing the planar heating element for generating an aerosol, comprising the steps of: (a) firing a conductive bead assembly to form a conductive bead layer; (b) adhering the conductive bead layer to one surface of the fired porous wick and further firing them; and (c) adhering a first terminal and a second terminal to both ends of the conductive bead layer, respectively.

According to a fourth aspect of the present invention,
there is provided an aerosol-generating device comprising a liquid storage part for storing a liquid aerosol-generating substrate; an aerosol-generating part for heating the aerosol-generating substrate to generate an aerosol; and a mouthpiece for discharging the generated aerosol according to the user's puff, wherein the aerosol-generating part comprises the planar heating element for generating an aerosol.

### Advantageous Effects

The planar heating element for generating an aerosol and the aerosol-generating device according to the present invention have the effect of enhancing the atomization amount of the liquid aerosol-generating substrate by generating planar heat in a large area of one surface of the wick even at low power density, and preventing the carbonization liquid phenomenon due to instantaneous heating or local heating of high temperature by heating without deviation for each area.

The method for manufacturing the planar heating element for generating an aerosol according to the present invention has the advantage that it is possible to flexibly change the shape of the conductive bead layer according to the various shapes of the porous wick, and thus various design modifications are easy.

### DESCRIPTION OF DRAWINGS

FIG. 1 shows (A) an actual photograph and (B) a schematic view of a conventional wick-heater structure comprising a heater in a pattern form.

FIG. 2 shows a schematic view of the planar heating element for generating an aerosol according to the present invention.

FIG. 3 shows a cross-sectional view of the planar heating element for generating an aerosol according to the present invention.

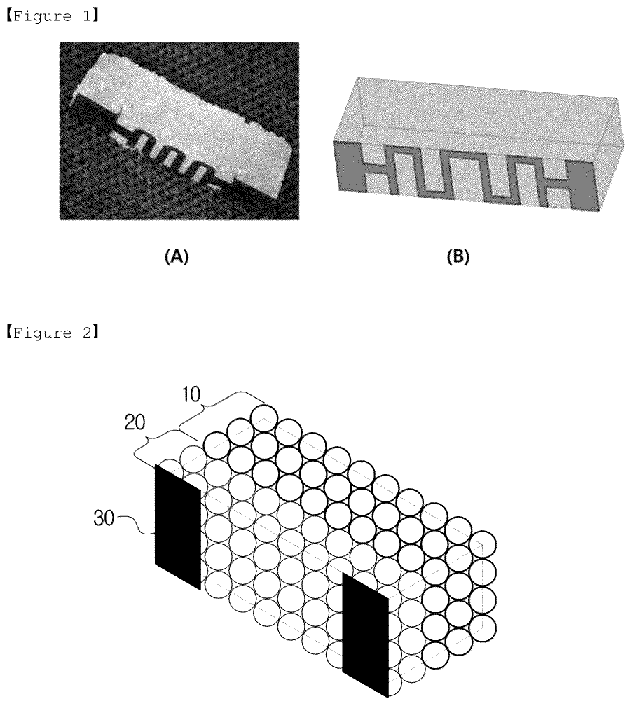

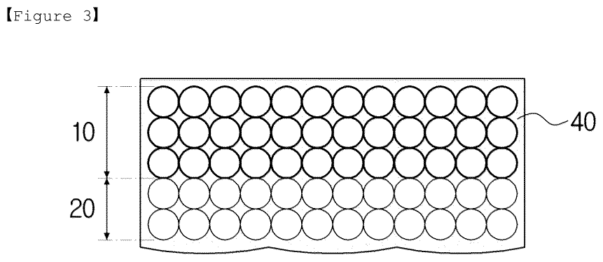

### BEST MODE

The terms and words as used in the present specification and claims should not be construed as limited to conventional or dictionary meanings, but should be construed as the meaning and concept consistent with the technical idea of the present invention based on the principle that the inventor can appropriately define the concept of the term to describe its own invention in the best way. Accordingly, the embodiments described in the present specification and the configurations shown in the drawings are only the most preferred embodiment of the present invention and do not represent all of the technical spirit of the present invention, and thus it should be understood that various equivalents and modifications may be substituted for them at the time of filing the present application.

In the drawings, the size of each component or a specific part constituting the component is exaggerated, omitted, or schematically illustrated for convenience and clarity of description. Thus, the size of each component does not fully reflect the actual size. If it is determined that the specific description of the related known functions or constitutions may unnecessarily obscure the gist of the present invention, the description thereof will be omitted.

In a conventional aerosol-generating device that vaporizes a liquid aerosol-generating substrate to generate an aerosol, there were problems in that the heater located on the lower surface of the wick is not heated in an area corresponding to the entire surface to generate heat, but was divided into a heated part and a non-heated part due to the limitation of a pattern form and size to cause atomization, and the liquid was carbonized due to the local heating phenomenon to result in burnt taste or harmful substances.

In order to solve the above-mentioned problems, the present inventors have introduced a planar heating element in which the entire conductive bead layer generates heat instead of local heating that occurs only in a specific area corresponding to the location of a heater in a pattern form by forming a conductive bead layer on one surface of a porous wick, and have led to providing a planar heating element for generating an aerosol by generating an aerosol through this, a method for manufacturing the same, and aerosol-generation comprising the same device.

Hereinafter, the present invention will be described in detail with reference to the accompanying drawings.

In the present specification, an “aerosol-generating substrate” is defined as a material capable of generating an aerosol. The aerosol-generating substrate may be a liquid composition, and specifically may include, but is not particularly limited to, a liquid composition based on nicotine, tobacco extract and/or various flavoring agents. In an embodiment, the aerosol-generating substrate may include at least one of propylene glycol and glycerin, and may further include at least one of ethylene glycol, dipropylene glycol, diethylene glycol, triethylene glycol, tetraethylene glycol, and oleyl alcohol. The aerosol-generating substrate may further include various additives such as cinnamon and capsaicin. The aerosol-generating substrate may include a material in the form of a gel or a solid as well as a liquid material having high fluidity, and the compositional components included in the substrate may vary depending on embodiments and are not limited to a specific ratio.

In the present specification, an “aerosol-generating device” is defined as a device that generates an aerosol using an aerosol-generating substrate for generating an aerosol that may be directly inhaled into the user's lungs through the user's mouth. For example, the aerosol-generating device may include, but is not particularly limited to, a liquid-type aerosol-generating device, a hybrid aerosol-generating device using a vaporizer and a cigarette together, and may further include various types of aerosol-generating devices.

In the present specification, a “planar heating layer” is defined as a layer that uniformly generates heat without local deviation for each area on one surface of a certain structure.

The present invention provides a planar heating element for generating an aerosol, comprising a porous wick 10 for absorbing a liquid aerosol-generating substrate; a conductive bead layer 20 for heating the absorbed liquid aerosol-generating substrate; and a terminal part 30 for delivering an electricity for heating to the conductive bead layer.

The planar heating element for generating an aerosol comprises a porous wick 10 for absorbing a liquid aerosol-generating substrate. The porous wick 10 may be configured to serve to absorb the liquid aerosol-generating substrate 40 from a liquid storage part and transfer it to the conductive bead layer 20 in which heat is generated.

The porous wick 10 is a structure comprising a plurality of beads and, for example, may be, but is not particularly limited to, a body-centered cubic (BCC) or a face-centered cubic (FCC) sphere packing structure, and may have various packing structures. The porous wick 10 may be a structure comprising porous beads, wherein the porous beads may be selected from the group consisting of glass beads, ceramic beads, alumina beads, and combinations thereof, and may preferably be glass beads, but is not particularly limited thereto as long as the structure comprises porous beads so that voids are formed in the structure and the liquid aerosol-generating substrate 40 may move. Compared with the fiber-based wick, the porous wick 10 has an advantage that the carbonization phenomenon of the wick does not occur due to instantaneous local heating because it is composed of porous beads.

The shape of the porous wick 10 is not particularly limited as long as it can easily absorb the liquid aerosol-generating substrate 40 from the liquid storage part, and may be designed and implemented in various shapes such as, for example, an H-like shape, a U-like shape, or a n-like shape.

The planar heating element for generating an aerosol comprises a conductive bead layer 20 for heating the absorbed liquid aerosol-generating substrate 40. The conductive bead layer 20 may be configured to serve to generate an aerosol by vaporizing the liquid aerosol-generating substrate 40 transferred from the porous wick 10 by heating.

The conductive bead layer 20 may be a layer having a plurality of conductive beads stacked on one surface of the porous wick. The conductive bead layer 20 may be a layer formed by stacking conductive beads capable of electric heating when electricity is supplied on the entire lower surface of the porous wick 10 instead of the heater in a pattern form located on or just below the lower surface of the conventional porous wick. Specifically, the conductive bead layer 20 may be a layer formed by being stacked on one surface of the porous wick 10 so that electric current flowing between the conductive beads uniformly flows without deviation for each area when electricity is supplied from the terminal part 30.

In the present specification, a “one surface” of the porous wick may be defined as an area formed by continuously connecting from one terminal to the other terminal while the porous beads exposed to the outside and located at the outermost side of the porous wick are in direct contact with the conductive beads, and may include both flat and curved surfaces.

The conductive bead layer 20 may be a planar heating layer for heating the conductive beads stacked on one surface of the porous wick 10 by electricity delivered from the terminal part 30. The conductive bead layer 20 has the effects of enhancing the amount of atomization by vaporizing the liquid aerosol-generating substrate 40 in a large area through planar heating on one side of the porous wick 10 when compared to the case of applying the heater in a pattern form, while preventing the liquid carbonization phenomenon that may be generated by instantaneous local heating due to high temperature by enabling planar heating through a relatively low power density.

The conductive bead may be selected from the group consisting of a conductive metal bead, a bead having a surface coated with a conductive material, and a combination thereof, but is not particularly limited thereto as long as the bead includes a conductive metal or a conductive material capable of delivering electric current supplied from the terminal par 30. Specifically, the conductive bead is selected from the group consisting of a ceramic bead, an alumina bead, a stainless steel bead, a zirconia bead, a silica bead, and a combination thereof, and, preferably, may be a ceramic bead, an alumina bead, or a stainless steel bead.

The average diameter of the conductive bead may be 30 μm or more, 35 μm or more, 40 μm or more, 45 μm or more, 50 μm or more, 55 μm or more, or 60 μm or more, and may be 200 μm or less, 190 μm or less, 185 μm or less, 180 μm or less, 175 μm or less, 170 μm or less, 165 μm or less, or 160 μm or less. When the average diameter of the conductive bead satisfies the above range, there is the effect of stacking the number of conductive bead capable of generating a planar heat enough to cause sufficient atomization on one surface having a limited area of the porous wick 10 to vaporize the liquid aerosol-generating substrate, and it is preferable to use conductive beads classified within a range of a certain diameter through a mesh of a certain standard as the conductive bead.

The average thickness of the conductive bead layer 30 formed by stacking the conductive beads may be 0.1 mm or more, 0.2 mm or more, 0.3 mm or more, 0.4 mm or more, 0.5 mm or more, 0.6 mm or more, or 0.7 mm or more, and may be 1.5 mm or less, 1.4 mm or less, 1.3 mm or less, or 1.2 mm or less. When the average thickness of the conductive bead layer 30 satisfies the above range, the conductive bead layer 20 having a thickness capable of generating heat enough to cause sufficient atomization of the liquid aerosol-generating substrate 40 absorbed through the porous wick 10 may be formed. The thickness of the conductive bead layer 30 may be designed differently depending on the thickness of the molding mold when the bead layer is manufactured.

The ratio (A/B) of the average thickness of the porous wick 10 (A) to the conductive bead layer 30 (B) may be 0.1 or more, 0.5 or more, 1 or more, 1.5 or more, 2 or more, or 2.5 or more, and may be 5 or less, 4.5 or less, 4 or less, 3.5 or less, or 3 or less. When the ratio (A/B) is less than 1, there may be problems that the amount of liquid to be consumed for aerosolization in the wick itself is small when the heating layer is heated, and excessive heating occurs in the heating layer instantaneously, so that the liquid burns or aerosolization does not occur, and when the ratio (A/B) is more than 5, there are problems that an excessive amount of heat is required to heat the porous wick, and there is a limitation in raising the overall temperature of the wick above a certain temperature, so that the amount of aerosol generation is limited.

The porous wick 10 preferably has, but is not particularly limited to, a thickness capable of accommodating an amount of liquid sufficient to generate an aerosol when the planar heating layer is heated twice.

The planar heating element for generating an aerosol comprises a terminal part 30 for delivering electricity for heating to the conductive bead layer 20. For example, the terminal part 30 may serve to supply electric current for electrically heating the conductive bead layer 20 by receiving electricity from the battery and delivering it to the conductive bead layer 20.

The terminal part 30 may comprise a first terminal and a second terminal respectively located separately at both ends of the conductive bead layer 20. Since the first terminal and the second terminal do not occupy a large area in the conductive bead layer 20 and are disposed only in certain areas of both ends spaced apart from each other, there is an effect that planar heating may occur in the entire area of the conductive bead layer 20 except for these.

In the present specification, “both ends” of the conductive bead layer are defined as including both ends located at both ends in the long edge direction in the conductive bead layer formed on one surface of the porous wick.

The first terminal and the second terminal may be disposed to be in close contact with both ends in the downward direction of the conductive bead layer 20, respectively. The size of the first terminal and the second terminal of the terminal part 30 is not particularly limited, but it is preferable to minimize the size of the terminal within the range of the size capable of supplying electricity to the conductive bead layer 20 in order to sufficiently secure an area for generating planar heating.

### BEST MODE

The method for manufacturing the planar heating element for generating an aerosol comprises the steps of: (1) stacking conductive beads on one surface of a fired porous wick 10 to form a conductive bead layer 20; (2) further firing the porous wick 10 having the formed conductive bead layer 20; and (3) adhering a first terminal and a second terminal to both ends of the conductive bead layer 20, respectively.

The shape of the fired porous wick 10 is not particularly limited as long as it can easily absorb the liquid aerosol-generating substrate 40 from the liquid storage part as described above.

The method for manufacturing the planar heating element for generating an aerosol comprises the step of (1) stacking conductive beads on one surface of a fired porous wick 10 to form a conductive bead layer 20. Step (1) is a step of forming a conductive bead layer 20 by stacking conductive beads on the lower surface of a fired porous wick 10, and the shape of the conductive bead layer 20 is also may be formed corresponding to the shape of the lower surface of the porous wick 10. For example, when the lower surface of the porous wick 10 has a n-like shape, the shape of the conductive bead layer 20 may also have a n-like shape, and there is an advantage that various design modifications are possible with respect to the shapes of the porous wick 10 and the conductive bead layer 20 in terms of forming the conductive bead layer 20 on the already fired porous wick 10 as described above. Specifically, the shape of the conductive bead layer may be shaped identically with the lower surface of the porous wick, or may be shaped as a conductive bead layer having an uneven structure by thickening only the thickness of a specific area of the conductive bead layer. The average diameter and average thickness of the beads included in the conductive bead layer 20 preferably satisfy the above-described ranges.

The method of manufacturing the planar heating element for generating an aerosol comprises the step of (2) further firing the porous wick 10 having the formed conductive bead layer 20. Step (2) may be a step of stacking conductive beads to form the conductive bead layer 20 on the porous wick 10, and then further firing them in a firing furnace at a certain temperature to strengthen the bond between the conductive bead layer 20 and the porous wick 10.

The method of manufacturing the planar heating element for generating an aerosol comprises the step of (3) adhering a first terminal and a second terminal to both ends of the conductive bead layer 20, respectively. Step (3) may be a step of disposing the first terminal and the second terminal at both ends of the conductive bead layer 20 spaced apart from each other. It may be a step of disposing the first terminal and the second terminal in close contact with both ends of the conductive bead layer 20, and the terminal is not particularly limited as long as it is a conductive material capable of passing an electric current. In addition, step (3) may be a step of forming a terminal for supplying electricity by embedding a stud on the conductive bead layer 20. The stud has the effect of lowering the temperature at which the heat heated through the planar heating layer is transferred through the terminal.

In addition, the method for manufacturing the planar heating element for generating an aerosol comprises the steps of: (a) firing a conductive bead assembly to form a conductive bead layer 20; (b) adhering the conductive bead layer 20 to one surface of the fired porous wick 10 and further firing them; and (c) adhering a first terminal and a second terminal to both ends of the conductive bead layer 20, respectively.

The method for manufacturing the planar heating element for generating an aerosol comprises the steps of (a) firing a conductive bead assembly to form a conductive bead layer 20. Step (a) may be a step of firing the conductive bead assembly formed by packing a plurality of conductive beads in a firing furnace to form the conductive bead layer 20. The average diameter and average thickness of the beads included in the conductive bead layer 20 preferably satisfy the above-described ranges.

The method of manufacturing the planar heating element for generating an aerosol comprises the step of (b) adhering the conductive bead layer 20 to one surface of the fired porous wick 10 and further firing them. Step (b) may be a step of adhering the conductive bead layer 20 formed by firing through step (a) to the lower surface of the porous wick 10, and forming a bonded structure of the porous bead layer 20 and the porous wick 10 through further firing. Through further firing, the porous bead layer 20 has an effect of strengthening the bond with the porous wick 10 while maintaining the existing shape.

The method of manufacturing the planar heating element for generating an aerosol comprises the step of (c) adhering a first terminal and a second terminal to both ends of the conductive bead layer 20, respectively. The description of step (c) is the same as described above in step (3).

The aerosol-generating device comprises a liquid storage part for storing a liquid aerosol-generating substrate 40; an aerosol-generating part for heating the aerosol-generating substrate 40 to generate an aerosol; and a mouthpiece for discharging the generated aerosol according to the user's puff, wherein the aerosol-generating part comprises the planar heating element for generating an aerosol.

The aerosol-generating device comprises a liquid storage part for storing a liquid aerosol-generating substrate 40. The liquid storage part may have a predetermined space to store a liquid aerosol-generating substrate 40 therein, and store the liquid aerosol-generating substrate 40 in the space. The liquid storage part may supply the stored liquid aerosol-generating substrate 40 to the porous bead layer 20 through the porous wick 10, and store the liquid aerosol-generating substrate 40 therein, and is not particularly limited in size and shape as long as it can store the liquid aerosol-generating substrate 40 therein and easily supply it to the porous wick 10.

The aerosol-generating device comprises an aerosol-generating part for heating the aerosol-generating substrate to generate an aerosol. The aerosol-generating part comprises the planar heating element for generating an aerosol comprising the conductive bead layer 20. Specific description of the planar heating element for generating an aerosol is the same as described above.

The aerosol-generating device comprises a mouthpiece for discharging the generated aerosol according to the user's puff, The mouthpiece may be a part in direct contact with the user's mouth in order to puff the aerosol generated from the aerosol-generating part. The mouthpiece may comprise an antibacterial material to suppress the generation of microorganisms due to contact with the mouth, and may comprise a flavoring element to add flavor. The mouthpiece is not particularly limited in size and shape as long as the aerosol generated through the aerosol-generating part can be easily delivered to the user.

Although the present invention has been described above with reference to limited examples and drawings, the present invention is not limited thereto, and it will be apparent that various modifications and variations may be made within the scope of the technical spirit of the present invention and equivalents of the claims to be described below by those skilled in the art to which the present invention pertains.

### DESCRIPTION OF SYMBOLS

10: Porous wick
20: Conductive bead layer
30: Terminal part
40: Liquid aerosol-generating substrate

1. A planar heating element for generating an aerosol, comprising:
a porous wick for absorbing a liquid aerosol-generating substrate;
a conductive bead layer for heating the absorbed liquid aerosol-generating substrate; and
a terminal part for delivering an electricity for heating to the conductive bead layer.

2. The planar heating element for generating an aerosol according to claim 1, wherein the conductive bead layer is a layer having a plurality of conductive beads stacked on one surface of the porous wick.

3. The planar heating element for generating an aerosol according to claim 2, wherein the conductive bead layer is a planar heating layer for heating the conductive beads stacked on one surface of the porous wick by electricity delivered from the terminal part.

4. The planar heating element for generating an aerosol according to claim 2, wherein the conductive beads are selected from the group consisting of conductive metal beads, beads having a surface coated with a conductive material, and combinations thereof.

5. The planar heating element for generating an aerosol according to claim 2, wherein the conductive beads have an average diameter of 50 to 200 μm.

6. The planar heating element for generating an aerosol according to claim 1, wherein the conductive bead layer has an average thickness of 0.1 to 1.5 mm.

7. The planar heating element for generating an aerosol according to claim 1, wherein the ratio (A/B) of the average thickness of the porous wick (A) to the conductive bead layer (B) is 0.1 to 5.

8. The planar heating element for generating an aerosol according to claim 1, wherein the porous wick is a structure comprising porous beads, and the porous beads are selected from the group consisting of glass beads, ceramic beads, alumina beads, and combinations thereof.

9. The planar heating element for generating an aerosol according to claim 1, wherein the terminal part comprises a first terminal and a second terminal respectively located separately at both ends of the conductive bead layer.

10. A method for manufacturing the planar heating element for generating an aerosol according to claim 1, comprising the steps of:
(1) stacking conductive beads on one surface of a fired porous wick to form a conductive bead layer;
(2) further firing the porous wick having the formed conductive bead layer; and
(3) adhering a first terminal and a second terminal to both ends of the conductive bead layer, respectively.

11. A method for manufacturing the planar heating element for generating an aerosol according to claim 1, comprising the steps of:
(a) firing a conductive bead assembly to form a conductive bead layer;
(b) adhering the conductive bead layer to one surface of the fired porous wick and further firing them; and
(c) adhering a first terminal and a second terminal to both ends of the conductive bead layer, respectively.

12. An aerosol-generating device comprising:
a liquid storage part for storing a liquid aerosol-generating substrate;
an aerosol-generating part for heating the aerosol-generating substrate to generate an aerosol; and
a mouthpiece for discharging the generated aerosol according to the user's puff,
wherein the aerosol-generating part comprises the planar heating element for generating an aerosol according to claim 1.
